(19) United States
(12) Patent Application Publication
(10) Pub. No.: US 2025/0317411 A1
(43) Pub. Date: Oct. 9, 2025

(54) Dynamic Adjustment of Playback Pacing in Pre-Recorded Conversations Based on User Preferences and Contextual Analysis

(71) Applicant: Jason Matthew Roos, Irvine, CA (US)

(72) Inventor: Jason Matthew Roos, Irvine, CA (US)

(21) Appl. No.: 18/628,854

(22) Filed: Apr. 8, 2024

(51) Int. Cl. H04L 51/216; G10L 13/00

(52) U.S. Cl. CPC H04L 51/216; G10L 13/00

(57) ABSTRACT

The present disclosure relates to a computer-implemented method for dynamically adjusting the playback pacing of pre-recorded conversations to enhance user experience. This method involves one or more servers tasked with receiving a set of user-specific data, including preferences for reading or listening, and a pre-recorded conversation composed of a series of individual messages, each linked to different conversation participants. The method includes determining the time a user needs to understand each message based on their preferences, classifying messages according to the sender's identity, and calculating a specific dwell time for message presentation. This dwell time dictates how long each message is presented to the user before moving to the next, ensuring the pacing of the conversation playback is tailored to the user's comprehension speed and preferences. The user device then sequentially presents these messages, each for its calculated duration, thereby customizing the conversation flow to mimic real-time interaction closely.

### FIELD OF INVENTION

The present invention relates generally to the field of digital communication technologies, specifically to methods and systems for dynamically adjusting the playback pacing of pre-recorded textual and auditory conversations.

### BACKGROUND

In the realm of digital communication, the quest to replicate the nuances of live interactions within pre-recorded conversations presents considerable challenges. Traditional systems for replaying such discussions, whether textual or auditory, typically adhere to a fixed-speed playback methodology. This approach, while functional, overlooks the dynamic nature of human communication, often leading to a user experience that feels unnatural and disconnected. In particular, these systems fail to account for the varying comprehension speeds and preferences of individual users, leading to a one-size-fits-all solution that can neither adapt to the context within a conversation nor cater to the specific needs of the user. Furthermore, existing methods tend to treat all messages with uniform importance, disregarding the potential to optimize message timing to enhance realism and engagement.

Another significant limitation of current technologies is their inability to effectively manage system notifications and conversational messages in a way that maintains the natural flow of a conversation. Notifications such as “John Doe has joined the chat” are often replayed without consideration for their impact on the conversation's rhythm, disrupting the user's experience. Moreover, the rigid approach to message timing does not allow for adjustments based on the relationship between messages or the context of the conversation, missing opportunities to create a more engaging and comprehensible interaction.

Additionally, while some advancements have been made in augmenting live interactions, these solutions do not address the unique challenges presented by pre-recorded conversations. They fail to remove superfluous delays or strategically introduce pauses that could emulate the rhythm of live interaction, thereby improving both comprehension and engagement. The absence of a method to classify the nature of message transitions further exacerbates these issues, leading to a playback experience that lacks the nuanced understanding of human communication dynamics.

The disclosed method seeks to address these shortcomings by dynamically adjusting the pacing of pre-recorded discussions. This approach is designed to provide a more realistic experience that is tailored to the user's individual reading or listening preferences, thereby overcoming the limitations of traditional fixed-speed playback methods. The consideration of factors such as system notifications, conversational messages, and the classification of message transitions, combined with user data, represents a significant departure from existing practices. It underscores the need for a method that can adapt to the intricacies of pre-recorded interactions, offering a solution that is both more engaging and more attuned to the user's needs.

It is within this context that the present invention is provided.

### SUMMARY

The invention provides a computer-implemented method for adjusting the playback pacing of pre-recorded conversations. This method involves a cooperative effort between one or more servers and a user device, where the servers are responsible for processing a set of user data, including reading or listening preferences, and a pre-recorded conversation consisting of separate messages from multiple entities. The method includes determining a required comprehension time for each message based on user data, classifying messages by sender identity, calculating a dwell time for each message, and presenting the messages in sequence with calculated dwell times on the user device.

In some embodiments, the user data may also incorporate demographic information of the user. This allows for a more nuanced determination of comprehension time, enhancing the personalization of the playback pacing to better suit the individual user's needs.

In further embodiments, messages within the pre-recorded conversation are classified as either system messages or user messages. This classification enables the method to apply different handling strategies for system versus user messages, ensuring a smooth and natural conversation flow.

Additionally, some embodiments include an adjustment of dwell times for system messages. This adjustment is made within predefined limits to prevent disruptions in the conversation's natural rhythm, maintaining an engaging user experience.

In such embodiments, sub-classifying user messages based on the target recipient allows for dwell times to be calculated with even greater precision. This feature enables the system to adjust playback speed more effectively, creating a playback experience that more closely mimics the pace of live interactions.

In other such embodiments, the method further comprises the step of sub-classifying user messages based on whether the sender of the message is the same as the sender of the next message. In such examples it may be the case that the dwell time for messages from the same sender as the next message is reduced or eliminated to replicate the rapid succession typical of live interactions. Furthermore, the dwell time for messages from the same sender as the previous message may be extended to compensate for the reduced dwell time of the previous message.

In some embodiments, the inclusion of a typing indicator during the dwell time before the next message is presented simulates the real-time typing process, adding to the immersive quality of the conversation playback.

In some embodiments, conversations can include both textual and auditory messages.

In some embodiments, the method converts textual messages to speech based on user preferences, utilizing text-to-speech technology. This conversion facilitates an auditory playback option, broadening the method's applicability. Adjusting the timing of text-to-speech playback for messages from entities other than the first user and for system messages ensures a seamless integration of auditory messages into the conversation flow, preserving the pace and continuity.

In some embodiments, allowing the user to pause and resume playback gives them control over their engagement with the pre-recorded conversation, catering to a range of interaction styles.

In some embodiments, presenting the conversation from a simulated first-person perspective immerses the user in the conversation, enhancing their connection to the content.

In some embodiments, implementing the method on a dedicated application ensures a consistent and optimized user experience, with the application receiving precise timing instructions from the servers.

In some embodiments, incorporating considerations for “thinking”, “transmission”, and “typing” times in the calculation of dwell times allows for a more detailed and accurate adjustment of playback pacing, closely replicating the nuances of live interaction.

In some embodiments, including the display of reaction emojis within the conversation at times calculated to simulate real-time interaction adds an additional layer of realism, mimicking the spontaneous nature of live conversations.

In some embodiments, the received conversation is an auditory or video conversation, and the method further comprises adjusting the speed of speech in auditory conversations without altering the pitch, wherein the lengthening or shortening of speech is based on the listener's preferences and comprehension speed.

In such auditory or video conversation embodiments, the method may further include altering the timing of attendees' entrance and exit in both auditory and visual representations within the user interface to optimize the flow of conversation.

### BRIEF DESCRIPTION OF THE DRAWINGS

Various embodiments of the invention are disclosed in the following detailed description and accompanying drawings.

FIG. 1 illustrates a flowchart depicting the method steps for adjusting the playback pacing of pre-recorded conversations according to user preferences.

FIG. 2 shows an example system architecture, detailing the interaction between a user, their device, and the servers through a cloud network architecture.

FIG. 3 presents an example user interface of a user device displaying a textual conversation from a simulated first-person perspective of the moderator, including interactions with AI chatbots, system messages, and user input features.

FIG. 4 illustrates an alternative user interface for simulating a video conference playback of an auditory conversation, featuring the display of active speaker indications, attendee lists, and control elements like a pause button to adjust conversation pacing according to user preferences.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, “user device” refers to any electronic device capable of receiving, processing, and displaying messages as part of a pre-recorded conversation. The user device may be a smartphone, tablet, laptop, desktop computer, smartwatch, or any other type of computing device with a display and the capability to interact with one or more servers. The user device is configured to execute a dedicated application or web-based interface that facilitates the presentation of messages in accordance with the calculated dwell times.

“User data,” as described herein, encompasses any information related to the first user that can influence the playback pacing of a pre-recorded conversation. This includes, but is not limited to, reading and listening preferences, demographic information such as age, education level, language proficiency, and any other data that can affect comprehension speed. User data may be explicitly provided by the user or inferred from user interactions and behaviors within the application or service. Additionally, the mere selection of a conversation by the user is considered part of “user data,” as the nature of the selected conversation itself may imply the user's reading preferences and/or demographics, particularly in scenarios involving anonymous users who do not have an account for saving preferences. For these users, the app relies on their conversation selection to gauge potential demographic details, given that the target audience may be indicated on the event card associated with the conversation. Reading preferences are explicitly indicated when the user, once engaged in a chat, selects “Change Speed” from the in-chat menu. This action allows the user to adjust the speed of the playback according to their preference, providing a direct input on their desired pacing for the conversation playback.

“Playback,” as used herein, refers to the process of presenting pre-recorded conversations to a user through the user device. These conversations can range from those that occurred historically, spanning back days, months, or even years, to those that transpired mere minutes or milliseconds prior to being played back. The term encompasses the playback of both manually recorded conversations and auto-generated conversations that are created dynamically by the system in response to user interactions or predefined criteria. The playback process is designed to simulate the flow and dynamics of a live conversation, adjusting the timing and sequence of message presentation based on user preferences and the calculated pacing parameters to enhance the user's engagement and understanding of the content. This broad interpretation of “playback” allows for a wide range of applications, from reviewing past interactions for information retrieval to experiencing auto-generated dialogues that provide real-time information or entertainment.

The term “comprehension time” refers to the estimated time required for a user to understand the content of a message. This estimation is based on a combination of user data and potentially other contextual factors, such as the complexity of the message content, the format of the message (textual or auditory), and the historical interaction patterns of the user. Comprehension time is calculated by the one or more servers using algorithms that may incorporate machine learning techniques to adapt and improve over time based on user feedback and engagement metrics.

“Dwell time,” as used herein, represents the duration for which a message is presented to the user before transitioning to the next message in the sequence. The calculation of dwell time takes into account the comprehension time, the classification of the message sender, and the nature of the transition between messages (e.g., from user to system, system to user, user to the same user, or user to a different user). Dwell time is dynamically adjusted to simulate the natural pacing of live conversations, enhancing the realism and user engagement with the pre-recorded conversation.

An example implementation of this invention could involve a server infrastructure comprising cloud-based services that process user data and pre-recorded conversations to calculate dwell times for each message. The servers could use advanced analytics and machine learning algorithms to refine the comprehension time estimations based on accumulating user interaction data. The user device, running a dedicated application, receives timing instructions from the servers and presents the messages with their calculated dwell times, adjusting playback in real time based on user interactions, such as pausing or resuming the conversation.

### DESCRIPTION OF DRAWINGS

The present invention relates to a computer-implemented method designed to enhance the playback of pre-recorded conversations by adjusting the pacing based on user data and the context of the conversation. The invention involves a collaborative process between servers and a user device, where the servers analyze user preferences, including reading and listening habits, and apply these preferences to modify the playback speed of messages within a conversation. This approach ensures that each message is presented for an optimal duration, known as dwell time, which is calculated to accommodate the user's comprehension capabilities and preferences.

The method begins with the collection of user data, which informs the servers about the user's reading or listening preferences. Following this, the servers receive a pre-recorded conversation that includes a series of messages from multiple entities. Each message is then analyzed to determine the required comprehension time for the user, taking into account the user's data. This method addresses the limitations of traditional fixed-speed playback methods by introducing a level of personalization and adaptability that enhances user engagement and comprehension.

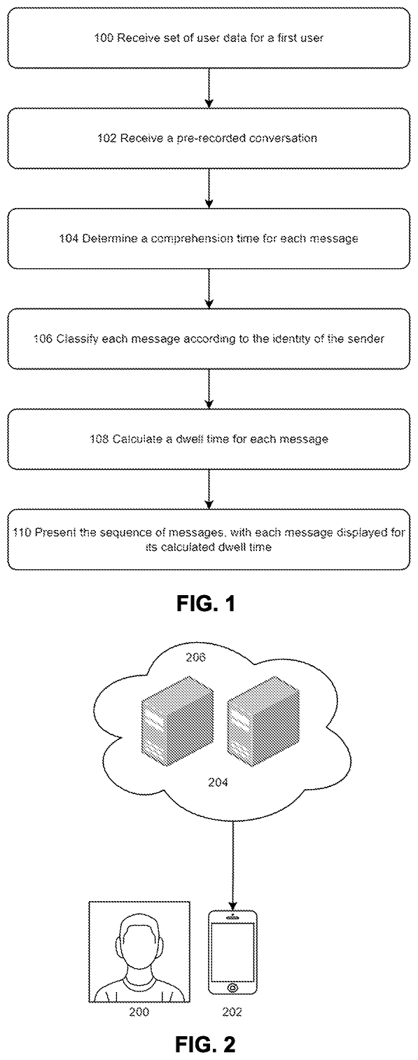

FIG. 1 presents a flowchart illustrating the method steps involved in adjusting the playback pacing of pre-recorded conversations to match user preferences. This figure delineates an example set of sequential operations performed by the system, comprising servers and a user device, to personalize the conversation playback experience.

The method commences with step 100, where the servers receive a set of user data for a first user. This data set includes critical information such as the user's reading or listening preferences, essential for tailoring the playback pace. Optionally, this user data may also encompass demographic information, offering a more granular basis for customization.

In step 102, the servers receive a pre-recorded conversation. This conversation is composed of a sequence of separate messages, with each message linked to one of several entities partaking in the conversation. This setup ensures a varied interaction framework. It is noted that the conversation may include both textual and auditory messages, accommodating various user preferences for message consumption.

Following the acquisition of the pre-recorded conversation, step 104 involves the servers determining a comprehension time for each message. This determination relies on the user data received in step 100 and is aimed at aligning the conversation flow with the user's personal comprehension speed, enhancing the overall engagement and understanding. This step may further refine the comprehension time based on the detailed demographic data of the user.

After establishing the comprehension time, step 106 sees the servers classifying each message according to the identity of the sender. This classification step is pivotal for further customization of the playback pacing, considering the nature of the message sender, whether it be a system notification or a user message. Additionally, messages may be sub-classified based on whether they are directed to the same or a different user than the preceding message, allowing for nuanced adjustments in pacing.

Subsequently, in step 108, the servers calculate a dwell time for each message. This dwell time, indicative of the duration that each message is presented to the user before moving to the next, is derived from the comprehension time determined in step 104 and from the classification of the message sender performed in step 106. The calculation of dwell time is fundamental in ensuring that each message is displayed for an optimal period, fostering a smooth and natural conversation rhythm. The dwell time for messages may be specifically adjusted for system messages to maintain conversation flow and reduced or eliminated for messages presented in rapid succession to replicate live interaction dynamics.

The final step in the process, step 110, involves the user device presenting the sequence of messages to the first user, with each message showcased for its calculated dwell time. This step represents the method's culmination, directly engaging the user with the personalized conversation playback, and demonstrating the system's capability to provide a customized and immersive conversation experience. The presentation may include a simulated typing indicator to enhance realism, and users may have the option to pause and resume playback for greater control. The method may be implemented on a dedicated application, ensuring a seamless experience.

Specific example implementations of the method may utilize RESTful APIs for data transmission between the servers and the user device, JSON for data exchange, and machine learning algorithms for the intelligent determination of comprehension times and calculation of dwell times. Additional features such as text-to-speech conversion for textual messages, adjusting playback speed of TTS for system messages, and displaying reaction emojis to simulate real-time interaction further enrich the user experience, making the conversation playback as engaging and natural as possible.

FIG. 2 illustrates an example implementation of the system architecture for adjusting the playback pacing of pre-recorded conversations according to user preferences.

A user 200 is shown, who interacts with the system via a user device 202. The user device 202 can be any personal computing device capable of connecting to the internet and displaying messages, such as a smartphone, tablet, laptop, or desktop computer. The device is equipped with a dedicated application or web-based interface that allows the user to access and engage with pre-recorded conversations. This interface is designed to receive user input, including reading or listening preferences and potentially demographic information, which is critical for personalizing the playback pacing of conversations.

The user device 202 communicates with a set of servers 204, which are responsible for executing the core functionalities of the method, including receiving user data, processing pre-recorded conversations, determining comprehension times for messages, classifying messages, and calculating dwell times. The servers 204 operate over a cloud network architecture 206. The cloud network architecture 206 can incorporate data analytics and monitoring tools to track system performance and user engagement metrics.

The communication between the user device 202 and the servers 204 is facilitated by a secure and efficient data transmission protocol, such as HTTPS, utilizing RESTful APIs or similar technologies for exchanging data in a structured format like JSON or XML.

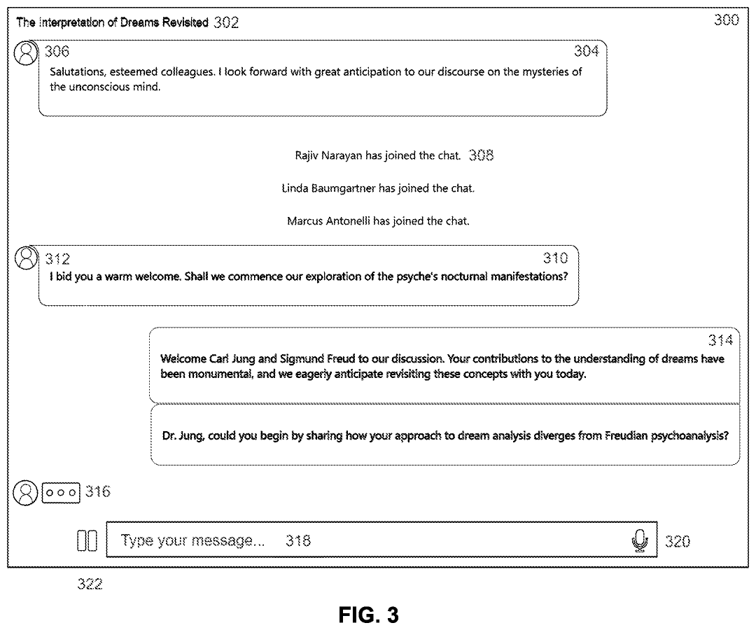

FIG. 3 illustrates an example user interface 300 of a user device displaying a textual conversation in the process of being played back, specifically showcasing an interaction between a moderator and multiple AI chatbots from a simulated first-person perspective of the moderator.

At the top of the displayed interface, the title of the conversation 302 is prominently shown, providing context and identifying the conversation's subject or participants for the user. This title serves as an introductory element, setting the stage for the interaction that follows.

Directly below the title, a first user message 304 appears on the left side of the interface, accompanied by a label 306 identifying the sender as an AI entity, specifically a Carl Jung AI chatbot persona.

Subsequent to the first message, a series of system messages 308 are displayed, indicating the addition of other chatbots to the conversation. These messages provide real-time context to the user, simulating the dynamic nature of live conversations by showing the joining of participants. Further down, a second user message 310 is positioned on the left, similar to the first user message, with a label 312 indicating another AI chatbot entity, this time a Sigmund Freud persona.

Below the message from the Sigmund Freud AI, a pair of user messages 314 sent by the moderator are shown on the right side of the interface. These messages are directed towards the Carl Jung chatbot, with the last displayed message triggering a typing indicator 316 adjacent to the Carl Jung label 306. This indicator signifies that the conversation is currently in a dwell time, allowing the user to process the moderator's inquiry before the Carl Jung chatbot's response is revealed.

At the bottom of the screen, a text box 318 is available for the moderator to compose messages, alongside a microphone symbol 320 for speech-to-text input and a pause button 322. The pause button is the sole interactive element during playback, enabling the user to control the pace of the conversation review by temporarily halting the progression of messages.

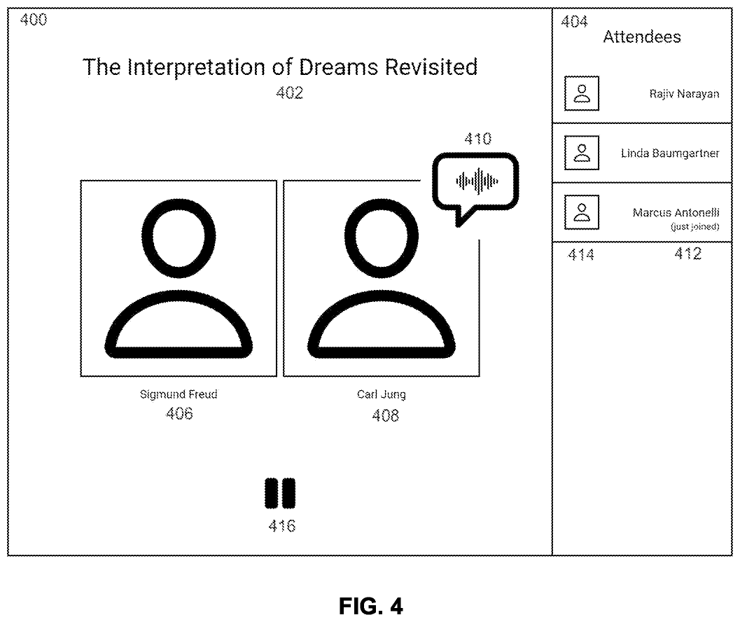

FIG. 4 presents an alternative embodiment of the user interface (UI) designed for simulating a video conference playback, focusing on auditory conversations. This embodiment showcases the UI 400 for “The Interpretation of Dreams Revisited” conversation playback, incorporating several key features to enhance user experience in an auditory context.

The title of the discussion 402 is displayed at the top. Adjacent to the title, on the top right, is an attendees list 404, which serves to inform the user of the participants in the conversation. Central in the UI are the labels for the AI chatbots currently engaged in conversation, specifically Sigmund Freud 406 and Carl Jung 408. A speech bubble 410 next to Carl Jung's profile label visually indicates that he is the one speaking at the moment, thereby guiding the user's attention to the active speaker in the conversation. Other attendees who are present in the chat but not currently speaking are listed in the attendees section 404. This section includes their profile names 412 and pictures 414, enhancing the visual and interactive elements of the UI. A pause button 416 is located at the bottom of the page, allowing users to control the playback of the conversation.

This embodiment incorporates advanced features tailored for auditory conversations, including the ability to time-stretch the speech of AI figures. This means that the speech can be lengthened or shortened without affecting the pitch, allowing the listener's preferences and comprehension speed to dictate the pacing of the conversation, analogous to adjusting dwell times for textual messages.

Additionally, the timing of attendees' entrance and exit from the conversation—and consequently, the appearance and disappearance of their representations from the UI—can be altered from the original timing to optimize conversation flow. This treatment is similar to how system messages in a textual context are managed differently from user messages. The appearance or disappearance of members from the interface, or any representation thereof, effectively serves as a “message” from the system, notifying the group of the members' arrival or departure. This assumes that the mere appearance or disappearance of members constitutes a significant communicative action, akin to an explicit message like “John Doe joined the chat.”

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner, as described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the computer-implemented method of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for adjusting playback pacing of pre-recorded conversations, the method executed by a combination of one or more servers and a user device, comprising:
Receiving a set of user data for a first user, the user data including at least a set of reading or listening preferences;
Receiving a pre-recorded conversation comprising a sequence of separate messages, each message associated with one of multiple entities involved in the conversation;
for each message in the sequence, determining a comprehension time required for the first user to digest the content of the message, the determination based on the received set of user data;
for each message in the sequence, classifying the message based on the identity of the entity that sent the message;
calculating, for each message in the sequence, a dwell time—the dwell time representing the length of time for which the message is to be presented to the first user before presenting the next message in the sequence, the calculation based on the determined comprehension time for the message and the classification of the message sender;
presenting, by the user device, the sequence of messages to the first user, each message presented for its respective calculated dwell time.

2. The method of claim 1, wherein the set of user data further includes demographic data of the first user, and wherein the determination of the comprehension time for each message is further based on the demographic data.

3. The method of claim 1, further comprising the step of displaying a typing indicator on the user device for a period of time overlapping the dwell time of the previous message before presenting the next message.

4. The method of claim 1, wherein the classification of messages includes identifying messages as either system messages or user messages.

5. The method of claim 4, further comprising adjusting the calculated dwell time for messages classified as system messages within the pre-recorded conversation to maintain the natural flow of the conversation, the adjustment constrained within predefined minimum and/or maximum limits.

6. The method of claim 4, wherein the method further comprises the step of sub-classifying user messages based on whether the sender of the message is the same as the sender of the next message.

7. The method of claim 6, wherein the dwell time for messages from the same sender as the next message is reduced or eliminated to replicate the rapid succession typical of live interactions.

8. The method of claim 7, wherein the dwell time for messages from the same sender as the previous message is extended to compensate for the reduced dwell time of the previous message.

9. The method of claim 1, wherein the pre-recorded conversation includes both textual and auditory messages.

10. The method of claim 1, wherein the method further comprises converting textual messages to speech using text-to-speech (TTS) technology based on the user's preference included in the set of user data.

11. The method of claim 10, wherein the timing of TTS playback for messages from entities other than the first user is adjusted so that the message sender is identified during a period of time overlapping the dwell time of the previous message.

12. The method of claim 10, further comprising adjusting the playback speed of TTS for system messages to ensure continuity with the typing and transmission of subsequent messages, thereby maintaining the pace of the conversation.

13. The method of claim 1, further comprising the step of allowing the first user to interact with the pre-recorded conversation by pausing and resuming playback, providing the user control over the pace of conversation review.

14. The method of claim 1, further comprising presenting the pre-recorded conversation in a simulated first-person perspective to enhance user immersion in the conversation.

15. The method of claim 1, wherein the method is implemented on a dedicated application run on the user device, the application configured to receive timing instructions from the one or more servers for presenting the sequence of messages.

16. The method of claim 1, wherein the calculation of dwell time for each message further incorporates considerations for one or more of “thinking”, “transmission”, and “typing” times.

17. The method of claim 1, wherein the method includes displaying reaction emojis to messages within the pre-recorded conversation at times calculated to simulate real-time interaction, the timing of each reaction based on a combination of factors including message notice, reading, reaction decision, and emoji selection times.

18. The method of claim 1, wherein the received conversation is an auditory or video conversation, further comprising adjusting the speed of speech in auditory conversations without altering the pitch, wherein the lengthening or shortening of speech is based on the listener's preferences and comprehension speed.

19. The method of claim 1, wherein the received conversation is an auditory or video conversation, further including altering the timing of attendees' entrance and exit in both auditory and visual representations within the user interface to optimize the flow of conversation.
